(19) United States
(12) Patent Application Publication
(10) Pub. No.: US 2006/0143371 A1
(43) Pub. Date: Jun. 29, 2006

(54) Integrated memory management apparatus, systems, and methods

(76) Inventors: John C. Rudelic, Folsom, CA (US); Sanjay Talreja, Folsom, CA (US); Mickey L. Fandrich, Folsom, CA (US)

Correspondence Address: INTEL CORPORATION, P.O. BOX 5326, SANTA CLARA, CA, 95056-5326, US

(21) Appl. No.: 11/023,777

(22) Filed: Dec. 28, 2004

(51) Int. Cl. G06F 13/00

(52) U.S. Cl. 711/106; 711/103; 711/104

(57) ABSTRACT

Apparatus and systems, as well as methods and articles, may perform operations including memory bank management and memory bus arbitration associated with a first memory module comprising non-refreshable memory cells and a controller, a second memory module coupled to the first memory module by a memory management control bus, or both. Some embodiments may also perform precharge and refresh operations associated with the second memory module.

### TECHNICAL FIELD

Various embodiments described herein relate to memory device technology generally, including apparatus, systems, and methods used in memory device management operations.

### BACKGROUND INFORMATION

Management operations associated with memory devices may include bus arbitration, bank management, dynamic random-access memory (DRAM) refresh, and DRAM precharge, among others. Memory bus arbitration may be performed by discrete logic, perhaps located in a microprocessor-based motherboard chipset. DRAM refresh and preharge functions may be performed by a host controller, including a main system processor in a personal computer. However, the use of main processor operational cycles to manage memory operations may be undesirable, since processor resources expended for such management operations may then be unavailable to execute software applications. Software or hardware interrupts associated with DRAM refresh and precharge operations may also complicate operating system activities, particularly when transitioning between normal mode operation and “sleep” modes of operation.

### BRIEF DESCRIPTION OF THE DRAWINGS

FIG. 1 is a block diagram of an apparatus and a system according to various embodiments of the invention.

FIG. 2 is a flow diagram illustrating several methods according to various embodiments of the invention.

FIG. 3 is a block diagram of an article according to various embodiments of the invention.

### DETAILED DESCRIPTION

Various embodiments disclosed herein may operate to integrate memory management functions into a memory module, perhaps utilizing these functions to control other memory modules. A “memory module,” in the context of various embodiments of this invention, includes a device comprising one or more memory cell arrays used by a computing system primarily for the purpose of storing data and/or instructions unrelated to memory management operations comprising bus arbitration, bank management, precharge, and refresh.

In the interest of clarity, various embodiments may describe a “first memory module” and a “second memory module” in order to differentiate between separate but commonly-controlled devices, or between devices comprising a variety of memory cell technologies. It is noted that these embodiments may include a plurality of memory modules, perhaps constructed as a die stack or arranged in other compact configurations.

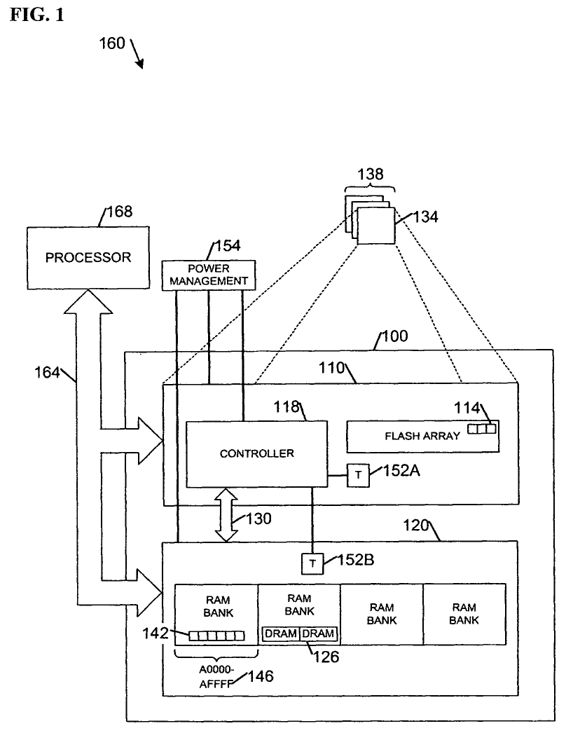

FIG. 1 comprises a block diagram of an apparatus 100 and a system 160 according to various embodiments of the invention. An apparatus 100 may include a first memory module 110, including non-refreshable memory cells 114 and a controller 118. The first memory module 110 may include flash memory, static random access memory (SRAM), electrically-erasable read-only memory (EEPROM), polymer memory, thin-film memory, or some other non-volatile memory, for example, or a combination of these memory technologies. The apparatus 100 may also include a second memory module 120, perhaps comprising DRAM devices 126, coupled to the first memory module 110 by a memory management control bus 130. Either or both of the first memory module 110 and the second memory module 120 may comprise a die 134, and the memory modules 110, 120 may be configured as a die stack 138.

The controller 118 may perform memory bank management and memory bus arbitration operations associated with the first memory module 110, the second memory module 120, or both. A memory bank management operation may, for example, include enabling or disabling a plurality of memory cells 142 corresponding to a selected address range 146. The controller 118 may also perform refresh and precharge operations associated with the second memory module 120, and may thus control a refresh interval and a precharge time associated with the second memory module 120.

The controller 118 may comprise a processor or perhaps discrete logic circuitry, and may be coupled to a temperature sensor 152A, 152B, for the purpose of determining a refresh interval, a precharge time, or both (e.g., to enhance memory device performance at a given temperature). A power management module 154 may also be coupled to the controller 118 to adjust a power supply parameter associated with the memory modules 110, 120, including voltage, current, and frequency, for example.

Other embodiments may be realized. A system 160 may, for example, include one or more of the apparatus 100 as well as a parallel bus 164 coupled to a first memory module 110 comprising non-refreshable memory cells 114 and a controller 118. The controller 118 may be microprocessor-based or implemented using discrete logic. The system 160 may also include one or more second memory modules 120 comprising EEPROM, DRAM, SRAM, flash memory, polymer memory, or thin-film memory, for example, or a combination of these technologies, coupled to the first memory module 110 by a memory management control bus 130. Thus, the first memory module, the second memory module, or both may comprise flash memory or some other non-volatile memory technology. In some embodiments of the system 160, the flash memory may comprise NOR flash memory, NAND flash memory, or both. In some embodiments of the system 160, data may be transferred to/from either of the memory modules 110, 120 across the parallel bus 164 to another location, including to a processor 168, for example.

The apparatus 100; memory modules 110, 120; memory cells 114, 142; controller 118; DRAM devices 126; memory management control bus 130; die 134; die stack 138; address range 146; temperature sensors 152A, 152B; power management module 154; system 160; parallel bus 164; and processor 168 may all be characterized as “modules” herein.

Such modules may include hardware circuitry, single or multi-processor circuits, memory circuits, software program modules and objects, firmware, and combinations thereof, as desired by the architect of the apparatus 100 and system 160, and as appropriate for particular implementations of various embodiments. The modules may be included in a system operation simulation package such as a software electrical signal simulation package, a power usage and distribution simulation package, a capacitance-inductance simulation package, a power/heat dissipation simulation package, a signal transmission-reception simulation package, or any combination of software and hardware used to simulate the operation of various potential embodiments. These simulations may be used to characterize or test the embodiments, for example.

It should also be understood that the apparatus and systems of various embodiments can be used in applications other than integrating memory management control functions into a memory module; and thus, various embodiments are not to be so limited. The illustrations of apparatus 100 and system 160 are intended to provide a general understanding of the structure of various embodiments, and they are not intended to serve as a complete description of all the elements and features of apparatus and systems that might make use of the structures described herein.

Applications that may include the novel apparatus and systems of various embodiments include electronic circuitry used in high-speed computers, communication and signal processing circuitry, modems, single or multi-processor modules, single or multiple embedded processors, data switches, and application-specific modules, including multilayer, multi-chip modules. Such apparatus and systems may further be included as sub-components within a variety of electronic systems, such as televisions, cellular telephones, personal computers, workstations, radios, video players, vehicles, and others.

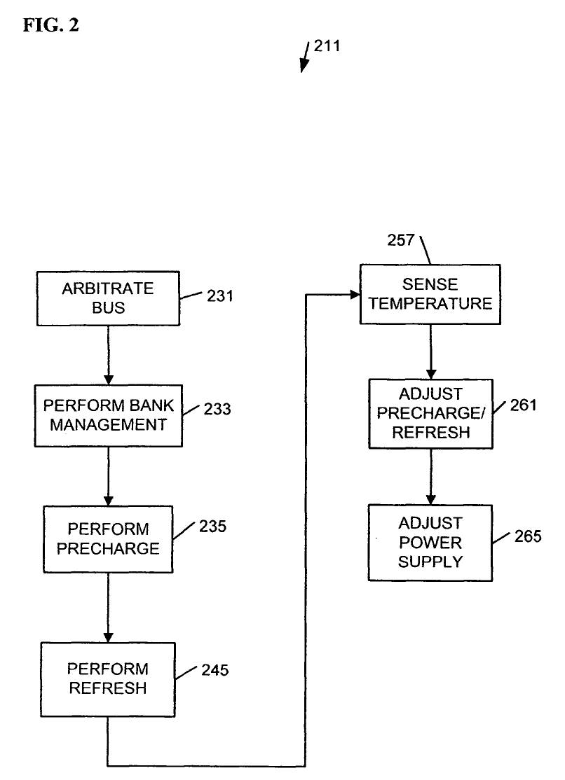

Some embodiments may include a number of methods. For example, FIG. 2 is a flow diagram illustrating several methods 211 according to various embodiments of the invention. One such method 211 may begin at block 231 with performing an operation utilizing a controller, such as a memory bus arbitration operation. The operation may be associated with a first memory module that includes the controller and comprises non-refreshable memory cells (e.g., flash memory), a second memory module coupled to the first memory module by a memory management control bus, or both. The memory management control bus may be separate from a data bus coupled to both the first memory module and to the at least one second memory module. In some embodiments, the first memory module and the second memory module may comprise a module stack, perhaps including two or more memory dice adjacent each other on a substantially co-planar substrate, or located proximate to each other in a vertical arrangement of dice. The second memory module may comprise a memory component that utilizes refresh operations, including a DRAM, for example.

The method 211 may continue with performing a memory bank management operation utilizing controller, at block 233, such as enabling and disabling a plurality of memory cells corresponding to a selected address range associated with the first memory module, the second memory module, or both.

The method 211 may include performing a precharge operation associated with the second memory module, at block 235, and performing a refresh operation associated with the second memory module, at block 245. The method 211 may also include sensing a temperature associated with the first memory module, the second memory module, or both, at block 257. The method 211 may further include adjusting one or both of a precharge time and a refresh interval associated with the second memory module, responsive to the temperature, at block 261. The method 211 may conclude with adjusting a power supply parameter associated with the first memory module, the second memory module, or both, including a voltage, a current, or a frequency, for example, at block 265.

It should be noted that the methods described herein do not have to be executed in the order described, or in any particular order. Moreover, various activities described with respect to the methods identified herein can be executed in repetitive, serial, or parallel fashion. Information, including parameters, commands, operands, and other data, can be sent and received in the form of one or more carrier waves.

Upon reading and comprehending the content of this disclosure, one of ordinary skill in the art will understand the manner in which a software program can be launched from a computer-readable medium in a computer-based system to execute the functions defined in the software program. One of ordinary skill in the art will further understand the various programming languages that may be employed to create one or more software programs designed to implement and perform the methods disclosed herein. The programs may be structured in an object-orientated format using an object-oriented language such as Java or C++. Alternatively, the programs can be structured in a procedure-orientated format using a procedural language, such as assembly or C. The software components may communicate using a number of mechanisms well known to those skilled in the art, such as application program interfaces or interprocess communication techniques, including remote procedure calls. The teachings of various embodiments are not limited to any particular programming language or environment.

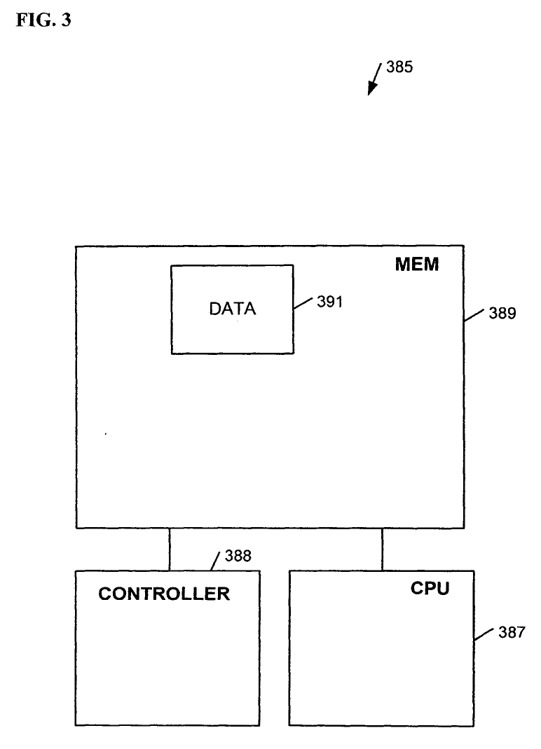

Other embodiments may be realized. For example, FIG. 3 is a block diagram of an article 385 according to various embodiments of the invention. Examples of such embodiments may comprise a computer, a memory system, a magnetic or optical disk, some other storage device, or any type of electronic device or system. The article 385 may include one or more processors 387 and/or controllers 388 coupled to a machine-accessible medium such as a memory 389 (e.g., a memory including an electrical, optical, or electromagnetic conductor). The medium may contain associated information 391 (e.g., computer program instructions, data, or both) which, when accessed, results in a machine (e.g., the processor(s) 387 and/or controllers 388) performing operations including memory bank management and memory bus arbitration. Such operations may be associated with a first memory module comprising non-refreshable memory cells and a controller, a second memory module coupled to the first memory module by a memory management control bus, or both.

Other activities may include precharging and/or refreshing a second memory module. The first memory module and the second memory module may comprise a module stack, perhaps including two or more memory dice adjacent each other on a substantially co-planar substrate, or as vertically stacked dice, described earlier. Further activities may include adjusting a power supply parameter associated with one of the first memory module, the second memory module, or both, including a voltage, a current, or a frequency.

Implementing the apparatus, systems, and methods disclosed herein may conserve circuit layout area by integrating memory management functions including bus arbitration, bank management, DRAM precharge, and DRAM refresh into a memory module and utilizing the integrated functions to control other memory modules. Additional improvements may include conserving resources expended by a main processor to perform DRAM precharge and refresh operations.

The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. An apparatus, including:
a first memory module comprising non-refreshable memory cells and a controller to perform at least one operation associated with a selected one of the first memory module and at least one second memory module coupled to the first memory module by a memory management control bus, the operation comprising at least one of memory bank management, memory bus arbitration, a second module refresh operation, and a second module precharge operation.

2. The apparatus of claim 1, wherein the memory bank management operation includes at least one of enabling and disabling a plurality of memory cells corresponding to a selected address range associated with at least one of the first memory module and the at least one second memory module.

3. The apparatus of claim 1, wherein the first memory module comprises at least one of a static random access memory (SRAM), an electrically-erasable read-only memory (EEPROM), a polymer memory, and a thin-film memory.

4. The apparatus of claim 1, wherein the first memory module comprises a flash memory.

5. The apparatus of claim 1, wherein the at least one second memory module comprises a dynamic random access memory (DRAM).

6. The apparatus of claim 1, wherein at least one of the first memory module and the at least one second memory module comprises a die.

7. The apparatus of claim 1, wherein the first memory module and the at least one second memory module comprise a die stack.

8. The apparatus of claim 1, wherein the controller comprises a processor.

9. The apparatus of claim 1, wherein the controller comprises discrete logic circuitry.

10. The apparatus of claim 1, further including:
a temperature sensor coupled to the controller to determine at least one of a refresh interval and a precharge time.

11. The apparatus of claim 10, wherein the at least one of a refresh interval and a precharge time is associated with at least one second memory module.

12. The apparatus of claim 1, further including:
a power management module coupled to the controller to adjust a power supply parameter associated with at least one of the first memory module and the at least one second memory module.

13. The apparatus of claim 12, wherein the power supply parameter comprises at least one of a voltage, a current, and a frequency.

14. A system, including:
a first memory module comprising non-refreshable memory cells and a controller to perform at least one operation associated with a selected one of the first memory module and at least one second memory module coupled to the first memory module by a memory management control bus, the operation comprising at least one of memory bank management, memory bus arbitration, a second module refresh operation, and a second module precharge operation; and
a parallel bus coupled to the first memory module to transfer data from the first memory module to another location.

15. The system of claim 14, wherein the at least one second memory module comprises at least one of an electrically erasable programmable read-only memory (EEPROM), a dynamic random access memory (DRAM), a static random access memory (SRAM), a polymer memory, and a thin-film memory.

16. The system of claim 14, wherein at least one of the first memory module and the at least one second memory module comprises flash memory.

17. The system of claim 16, wherein the flash memory comprises at least one of a NOR flash memory and a NAND flash memory.

18. The system of claim 14, wherein the controller comprises at least one of a processor and discrete logic.

19. A method, including:
performing an operation by a controller comprising at least one of memory bank management and memory bus arbitration, wherein the operation is associated with at least one of a first memory module including the controller and comprising non-refreshable memory cells, and at least one second memory module coupled to the first memory module by a memory management control bus.

20. The method of claim 19, wherein the memory bank management operation includes at least one of enabling and disabling a plurality of memory cells corresponding to a selected address range associated with at least one of the first memory module and the at least one second memory module.

21. The method of claim 19, wherein the first memory module includes flash memory.

22. A method, including:
performing an operation by a controller including at least one of a refresh operation and a precharge operation, wherein the operation is associated with at least one second memory module coupled by a memory management control bus to a first memory module including the controller and comprising non-refreshable memory cells.

23. The method of claim 22, wherein the control bus is separate from a data bus coupled to both the first memory module and to the at least one second memory module.

24. The method of claim 22, further including:
sensing a temperature associated with at least one of the first memory module and the at least one second memory module; and
adjusting at least one of a refresh interval and a precharge time associated with the at least one second memory module, responsive to the temperature.

25. The method of claim 22, wherein the at least one second memory module includes a dynamic random access memory (DRAM) component.

26. An article including a machine-accessible medium having associated information, wherein the information, when accessed, results in a controller performing at least one of:
an operation associated with a selected one of a first memory module comprising non-refreshable memory cells and including the controller and at least one second memory module coupled to the first memory module by a memory management control bus, comprising at least one of memory bank management and memory bus arbitration; and
an operation associated with the at least one second memory module comprising at least one of a refresh operation and a precharge operation.

27. The article claim 26, wherein the first memory module and the at least one second memory module comprise a module stack.

28. The article claim 27, wherein the module stack comprises at least two memory dice adjacent each other on a substantially co-planar substrate.

29. The article of claim 26, wherein the information, when accessed, results in a controller performing:
adjusting a power supply parameter associated with one of the first memory module and the at least one second memory module, comprising at least one of voltage, current, and frequency.
